(19) United States
(12) Patent Application Publication
(10) Pub. No.: US 2007/0089874 A1
(43) Pub. Date: Apr. 26, 2007

(54) Cooling system for a work machine

(76) Inventors: John E. Tuntland, Qingdao (CN); Ronald L. Dupree, Washington, IL (US); Sean W. Johnson, Qingdao (CN); Deepak Tiwari, Evanston, IL (US); Roland E. Weisman, Buckeye, AZ (US); Jennifer Yanfang Wu, Naperville, IL (US); Eugene E. Zueck, Clayton, NC (US)

Correspondence Address: CATERPILLAR INC.;100 N.E. ADAMS STREET, PATENT DEPT., PEORIA, IL, 616296490, US

(21) Appl. No.: 11/584,911

(22) Filed: Oct. 23, 2006

Related U.S. Application Data
(60) Provisional application No. 60/729,740, filed on Oct. 24, 2005.

(51) Int. Cl. F01P 1/06; G05D 15/00

(52) U.S. Cl. 165/280; 123/41.31

(57) ABSTRACT

A cooling system for a work machine may comprise a reservoir configured to hold a supply of fluid, a source of pressurized fluid and a valve configured to receive the pressurized fluid from the source of pressurized fluid. A first working unit and a second working unit may be connected to the valve in parallel. One of The first and second working units may be adapted to receive pressurized fluid on a priority basis from the valve. The first and second working units may be fluidly connected to the reservoir by a circulation conduit and may be connected to a first heat exchanger by a bypass conduit. The bypass conduit may be configured to pass only a portion of the fluid flow to be passed from the first and second working units to the first heat exchanger. The first heat exchanger may be fluidly connected to the reservoir and may be adapted to pass the portion of the fluid flow to the reservoir.

### RELATION TO OTHER PATENT

This application claims the benefit of prior provisional patent application Ser. No. 60/729,740 filed Oct. 24, 2005.

### TECHNICAL FIELD

The present disclosure relates generally to a cooling system, more particularly, to a cooling system for a work machine.

### BACKGROUND

Generally a work machine may be provided with a cooling device such as a radiator for cooling an engine, and/or an oil cooler for cooling hydraulic fluid and/or an oil radiator for cooling transmission oil to prevent overheating and/or system failure.

A work machine is generally configured with three independent cooling systems as set forth above. One example of such a cooling systems is disclosed in the U.S. Pat. No. 4,535,729 to Faylor issued Aug. 20, 1985.

The '729 patent discloses an integrated cooling system for cooling a vehicle engine, transmission oil, and auxiliary hydraulic function oil. A first oil cooler has an oil intake and outlet in communication with and for circulating the transmission oil in the cooler. The cooler has a connection to the first section for transferring coolant from the latter to the first oil cooler. A second oil cooler has an oil inlet and outlet in communication with and for circulating auxiliary hydraulic oil through the cooler that the latter cooler has a connection to the coolant in the second section for transferring coolant from the second section to the second cooler. The first and second coolant discharge conduit means receive the respective coolant from the first and second coolers and are connected to the intake of the pump.

In the '729 patent, all of the hydraulic oil flows through the second oil cooler cause a low start-up efficiency especially when the temperature is low. During the hydraulic system in full operation, because of lack of sufficient heat exchange with the second cooler, the temperature of the hydraulic system cannot be sufficiently reduced and cause overheating and/or system failure. The three independent cooling systems also occupy more space on the work machine.

The disclosed cooing system for a work machine is directed to overcoming one or more of the problems outlined above with respect to work machine cooling system.

### SUMMARY OF THE INVENTION

One aspect of the present disclosure may include a cooling system for a work machine. The cooling system may comprise a reservoir configured to hold a supply of fluid, a source of pressurized fluid and a valve configured to receive the pressurized fluid from the source of pressurized fluid. A first working unit and a second working unit may be connected to the valve in parallel. One of The first and second working units may be adapted to receive pressurized fluid on a priority basis from the valve. The first and second working units may be fluidly connected to the reservoir by a circulation conduit and may be connected to a first heat exchanger by a bypass conduit. The bypass conduit may be configured to pass only a portion of the fluid flow to be passed from the first and second working units to the first heat exchanger. The first heat exchanger may be fluidly connected to the reservoir and may be adapted to pass the portion of the fluid flow to the reservoir.

According to another aspect, the present invention is directed toward a method of operating a cooling system. The method may comprise pressurizing fluid, directing the fluid from a reservoir through a fluid pressurized source to a valve. The fluid may be directed to a first working unit and a second working unit in parallel. A one of the first and second working units may be adapted to receive pressurized fluid on a priority basis from the valve. The fluid may be passed from the first and second working units to the reservoir by a circulation conduit. A portion of the fluid may be directed from the first and second working units by a bypass conduit to a first heat exchanger. The portion of the fluid may be directed from the first heat exchanger to the reservoir.

According to another aspect, the present invention is directed toward a work machine may have a first cooling system that may have a first heat exchanger, a second cooing system that may have a second heat exchanger and a third cooling system that may have a third heat exchanger. The first cooling system may comprise a reservoir configured to hold a supply of fluid, a source of pressurized fluid and a valve configured to receive the pressurized fluid from the source of pressurized fluid. A first working unit and a second working unit may be connected to the valve in parallel. One of The first and second working units may be adapted to receive pressurized fluid on a priority basis from the valve. The first and second working units may be fluidly connected to the reservoir by a circulation conduit and may be connected to a first heat exchanger by a bypass conduit. The bypass conduit may be configured to pass only a portion of the fluid flow to be passed from the first and second working units to the first heat exchanger. The first heat exchanger may be fluidly connected to the reservoir and may be adapted to pass the portion of the fluid flow to the reservoir.

### BRIEF DESCRIPTION OF THE DRAWINGS

FIG. 1 illustrates a functional block diagram of cooling system for a work machine incorporating certain disclosed embodiments;

FIG. 2 illustrates another functional block diagram of cooling system for a work machine incorporating certain disclosed embodiments;

FIG. 3 is a cross-sectional linkage structure illustrating a bypass conduit connecting to a circulation conduit.

FIG. 4 is a diagrammatic cross-sectional structure of a cooler with a radiator for a work machine.

### DETAILED DESCRIPTION

Reference will now be made in detail to exemplary embodiments, which are illustrated in the accompanying drawings. Wherever possible, the same reference numbers will be used throughout the drawings to refer to the same or like parts.

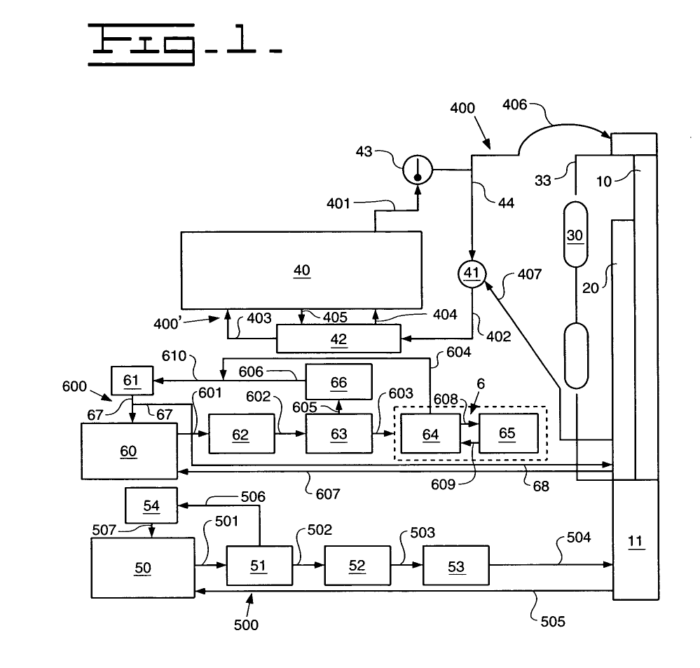

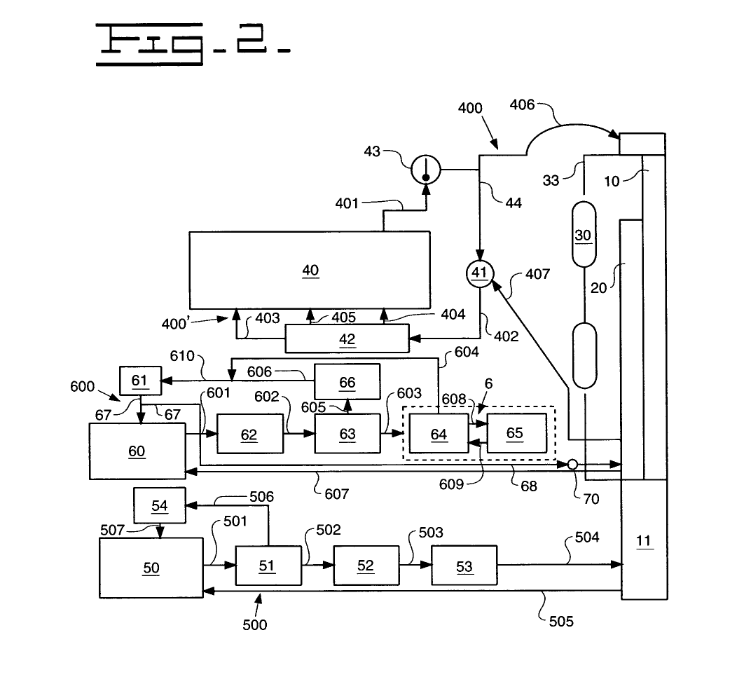

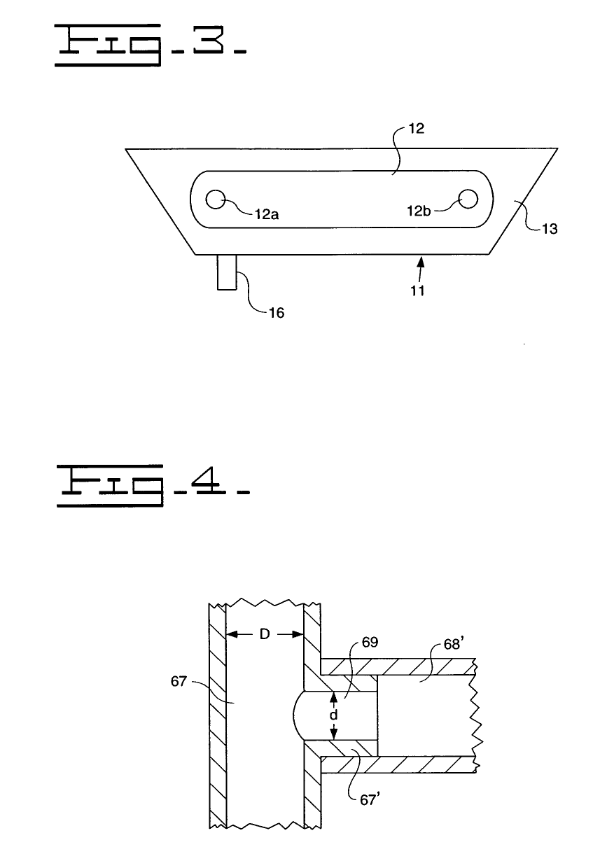

Referring to FIG. 1 and FIG. 2, they illustrate two embodiments of cooling systems of a work machine. The work machine may refer to any type of mobile machine that performs some type of operation connected to a particular industry, such as mining, construction, farming, transportation, etc. and operates between or within work environments (e.g., construction site, mine site, power plants, on-highway applications, etc.). Work machines include on-highway vehicles, commercial machines, such as trucks, cranes, earth moving vehicles, mining vehicles, backhoes, material handling equipment, farming equipment, marine vessels, aircraft, and any type of movable machine that operates in a work environment.

As shown in FIG. 1 and FIG. 2□ the work machine may include a steering and implement hydraulic (a first) cooling system 600, an engine (a second) cooling system 400 and a transmission (a third) cooling system 500. The cooling systems can be set up according to practical practice, for example to choose one or more of the cooling systems set forth above.

The engine cooling system 400 may include an engine unit 40, a circulating pump 41, a thermostat valve 43, a lube cooler 42 and a radiator 10. The engine unit 40 may be connected to the thermostat valve 43. The thermostat valve 43 may be connected to the radiator 10 and the radiator 10 may be connected to circulating pump 41. The circulating pump 41 may be connected to a lube cooler 42 and the engine unit 40 in series. A bypass conduit 44 may be connected to thermostat 43 and the circulating pump 41. The above-mentioned components may form a cooling circuit 400′, which is indicated by the arrows, of the engine cooling system.

The transmission cooling system may include a cooler 11 that may be connected to the low portion of the radiator 10, a transmission with oil tank 50, a transmission pump 51, a torque converter 52, an oil filter 53 and a valve 54. The transmission with oil tank 50 may be connected to a transmission pump 51 by circulation conduit 501. Circulation conduit may be divided into two branches 502, 506 after the transmission pump 51. One branch conduit 506 may be connected to the valve 54 and then connected to the transmission with oil tank 50. Another branch conduit 502 may be connected to torque converter 52 and the transmission oil filter 53 in series. The transmission oil filter 53 may be connected to the cooler 11. The cooler 11 may be connected to the transmission with oil tank 50. The transmission may include gears and clutch as disclosed in the prior art.

Referring to FIG. 4, the cooler 11 may have a bottom compartment 13 which may be connected to the lower portion of a water radiator 10. A core 12 may be disposed in the bottom compartment 13. The core 12 may have an inlet 12a and an outlet 12b for the transmission oil or the hydraulic fluid passing through. An outlet port 16 may be connected to the bottom compartment 13.

The steering and implement hydraulic cooling system may include: a cooler 20 of the fluid to air type, a hydraulic fluid tank (reservoir) 60, a hydraulic fluid filter 61, a fluid pressurizing source (pump) 62, a priority valve 63, an implement hydraulic unit 66 and a steering unit 6. The steering unit 6 may comprise a steering valve 64 and a steering cylinder 65 that may form a loop by circulation conduits 608, 609. The hydraulic fluid tank 60 may be connected to the pump 62 and priority valve 63 in series by circulation conduits 601, 602. The circulation conduit may be divided into two branch conduits from the priority valve 63. One branch conduit 605 may be connected to the implement hydraulic unit 66 and another branch conduit 603 may be connected to the steering unit 6 in parallel relation. A conduit 606 connected to the implement hydraulic unit 66 and a conduit 604 connected to the steering valve 64 may be joined into a conduit 610 and may be connected to the hydraulic fluid filter 61. The hydraulic fluid filter 61 may be connected to the hydraulic fluid tank 60 by a circulation conduit 67 and be connected to the cooler 20 by a bypass conduit 68. The cooler 20 may be fluidly connected to the fluid tank 60 by a circulation conduit 607.

Referring to FIG. 1 and FIG. 2, the cooler 20 may be disposed inboard of the first radiator 10. A shroud 33 with an inlet may be positioned adjacent to the first radiator 10. A fan 30 may be positioned in the inlet of the shroud 33.

Further referring to FIG. 2, a thermostat valve 70 may be positioned in the line of the bypass conduit and adjacent to the cooler 20, which may be movable to the hydraulic fluid passing position in response to the temperature reaching a predetermined temperature.

Referring to FIG. 4, an orifice 69 defined by an outlet port 67′ of the circulation conduit may be positioned in the line of the bypass conduit 68. The outlet port 67′ may be connected to one end 68′ of the bypass conduit 68. The diameter d of the outlet port 67′ may be smaller than the diameter D of the bypass conduit. The outlet port may be integrally formed with the circulation conduit. The outlet port may be formed by other structure known in the art.

### INDUSTRIAL APPLICABILITY

Referring to FIG. 1, in operation, when the cooling water temperature in the radiator reaches a certain temperature, the thermostat valve 43 may open the bypass conduit 44 by a control circuit. Pump 41 may pump water from engine unit 40 through a conduit 401, the thermostat valve 43, bypass 44, pump 41, a conduit 402, the lube oil cooler 42 and return to the engine unit 40 through a conduit 403. The lube oil cooler 42 may be fluidly connected to the engine unit 40 by an inlet conduit 404 and an outlet conduit 405 to form a circulation of the engine lube oil. The opening thermostat valve may prevent the cooling water from circulating through the radiator 10 in order to bring the cooling water temperature up to operating temperature, and such that when the cooling water temperature may be above a certain temperature, the thermostat valve may close the bypass conduit 44 by the control circuit. Pump 41 may pump water from engine unit 40 through the conduit 401, the thermostat valve 43, a conduit 406, the radiator 10, a conduit 407, the pump 41, the conduit 402, the lube oil cooler 42 and returns to the engine unit 40 through the conduit 403. The lube oil cooler 42 may be fluidly connected to the engine unit by an inlet conduit 404 and an outlet conduit 405 to form a circulation of the engine lube oil. This circulation may allow the cooling water to circulate through the radiator to reduce the cooling water temperature to a desired operating temperature.

The cooling method of the transmission cooling system 500 may include passing the transmission oil from transmission oil tank 50 through a conduit 501, the pump 51, a conduit 502, the torque converter 52, a conduit 503, the oil filter 53 and a conduit 504 to the cooler 11. The transmission oil may be passed from the cooler 11 through a conduit 505 to the transmission with oil tank 50. When the pressure in the pump may reach a certain value, a part of the transmission oil may be passed from the pump 51 through a conduit 506 to the valve 54 and then to the transmission with oil tank 50 through a conduit 507.

In the cooler 11, water cooled in the radiator 10 may go down through conduits to the bottom compartment 13. The transmission oil heated in operation may be passed into the core 12 through inlet 12a. The transmission oil may exchange heat with the cooled water that may come from the radiator. After releasing heat to the water in the bottom compartment 13, the transmission oil may be passed out of the core 12 through the outlet 12b and return to the transmission with oil tank 50 through the conduit 505. During this circulation, transmission oil exchange heat with water in the cooler 11 to reduce the transmission oil temperature to a desired operating temperature.

The cooling method of the steering and implement hydraulic cooling system may include pumping the hydraulic fluid from the hydraulic fluid tank 60 to the hydraulic oil pump 62 through a conduit 601, then to the priority valve 63 through a conduit 602. The hydraulic fluid may be passed into implement hydraulic unit 66 through one branch conduit 605 and then to the filter 61 through a conduit 606. When the work machine in steering operation, the hydraulic fluid may be passed from priority valve 63 to the steering unit 6 through a branch conduit 603, prior to be passed the implement hydraulic unit 66, and then to the filter 61 through a conduit 604. As shown in FIG. 1 and FIG. 2, the conduit 604 and 606 may be joined into a conduit 610 before connected to the filter 62. A portion of hydraulic fluid may be passed from the filter 61 to the fluid tank 60 through the circulation conduit 67. The other portion of hydraulic fluid may be passed to the cooler 20 through the bypass conduit 68 and then be returned to the hydraulic tank 60 through a conduit 607. In the steering unit 6, hydraulic fluid may be passed to steering cylinder 65 from the steering valve 64 through a conduit 608 and be returned to the steering valve 64 through a conduit 609, which may form a circulation of the steering unit. Within this circulation, hydraulic oil may exchange heat with the air in the cooler 20 to reduce the hydraulic fluid temperature to a desired operating temperature.

Further referring to FIG. 2, the operation of the engine cooling system 400 and the transmission cooling system 500 in FIG. 2 may be the same as in FIG. 1.

The cooling method of the steering and implement hydraulic cooling system may operate like following. When the hydraulic fluid temperature may be blow a certain temperature, the thermostat valve 70 may be closed by a control circuit. The hydraulic fluid may be pumped from the hydraulic fluid tank 60 to the hydraulic oil pump 62 through a conduit 601, then to the priority valve 63 through a conduit 602. A portion of the hydraulic fluid may be passed from priority valve 63 to the steering unit 6 through a branch conduit 603 and then to the filter 61 through a conduit 604. The other portion of the hydraulic fluid may be passed to implement hydraulic unit 66 through another branch conduit 605 and then to the filter 61 through a conduit 606. As shown in FIG. 1 and FIG. 2, the conduit 604 and 606 may be joined into a conduit 610 and connected to the filter 62. The hydraulic fluid may be passed from the filter 61 to the fluid tank 60 through the circulation conduit 67. In the steering unit 6, the hydraulic fluid may be passed into steering cylinder 65 from the steering valve 64 through a conduit 608 and be returned to the steering valve 64 through a conduit 609, which may form a circulation of the steering unit.

When the hydraulic fluid temperature may reach a certain temperature, the thermostat valve 70 may be opened by a control circuit. The hydraulic fluid may be pumped from the hydraulic fluid tank 60 to the hydraulic oil pump 62 through a conduit 601, then to the priority valve 63 through a conduit 602. The hydraulic fluid may be passed into implement hydraulic unit 66 through one branch conduit 605 and then to the filter 61 through a conduit 606. When the work machine in steering operation, the hydraulic fluid may be passed from priority valve 63 to the steering unit 6 through a branch conduit 603, prior to be passed the implement hydraulic unit 66, and then to the filter 61 through a conduit 604. As shown in FIG. 1 and FIG. 2, the conduit 604 and 606 may be joined into a conduit 610 and be connected to the filter 62. A portion of hydraulic fluid may be passed from the filter 61 to the fluid tank 60 through the circulation conduit 67. The other portion of hydraulic fluid may be passed to the cooler 20 by a bypass conduit 68 and then be returned to the hydraulic tank 60 through a conduit 607. In the steering unit 6, hydraulic fluid may be passed to steering cylinder 65 from the steering valve 64 through a conduit 608 and return to the steering valve 64 through a conduit 609, which may form a circulation of the steering unit. Within this circulation, hydraulic oil may exchange heat with the air in the cooler 20 to reduce the hydraulic fluid temperature to a desired operating temperature.

During the operation of the work machine, the fan 30 may blow air through both the first radiator 10 and the cooler 20 for heat exchange, which may reduce the temperature of the engine system, the transmission system and the steering and implement hydraulic system.

It will be apparent to those skilled in the art that various modifications and variations can be made to the disclosed the radiator and work machine. Other embodiments will be apparent to those skilled in the art from consideration of the specification and practice of the disclosed sealing box and pressured cab. It is intended that the specification and examples be considered as exemplary only, with a true scope may be indicated by the following claims and their equivalents.

What is claimed is:

1. A cooling system for a work machine, comprising:
a reservoir configured to hold a supply of fluid;
a source of pressurized fluid;
a valve configured to receive the pressurized fluid from the source of pressurized fluid;
a first working unit and a second working unit being connected to the valve in parallel, one of said first and second working units being adapted to receive pressurized fluid on a priority basis from said valve, said first and second working units being fluidly connected to the reservoir by a circulation conduit and being connected to a first heat exchanger by a bypass conduit, said bypass conduit being configured to pass only a portion of the fluid flow passed from the first and second working units to the first heat exchanger; and
said first heat exchanger being fluidly connected to the reservoir and being adapted to pass said portion of the fluid flow to the reservoir.

2. The cooling system as claimed in claim 1, including a filter disposed in the line of the circulation conduit.

3. The cooling system as claimed in claim 2, wherein said filter being positioned between the reservoir and the bypass conduit.

4. The cooling system as claimed in claim 1, wherein said first working unit being an implement hydraulic unit.

5. The cooling system as claimed in claim 1, wherein said second working unit being a steering unit.

6. The cooling system as claimed in claim 1, wherein said valve being a priority valve.

7. The cooling system as claimed in claim 1, including an orifice defined by a narrow conduit part having an inner diameter being smaller than the inner diameter of the circulating conduit, said orifice being disposed in the line of the bypass conduit, said orifice passing a smaller amount of fluid flow than the fluid flow passed through the circulating conduit.

8. The cooling system as claimed in claim 7, said orifice being located adjacent to the circulation conduit.

9. The cooling system as claimed in claim 1, including a control valve being positioned in the line of the bypass conduit.

10. The cooling system as claimed in claim 9, wherein said control valve being located adjacent to the first heat exchanger.

11. The cooling system as claimed in claim 9, wherein said control valve being a thermostat valve, said thermostat valve being movable to a fluid passing position in response to the temperature reaching a predetermined temperature.

12. The cooling system as claimed in claim 1, said first heat exchanger being a cooler of fluid to air type.

13. A method of operating a cooling system, comprising:
pressurizing fluid;
directing the fluid from a reservoir through a fluid pressurized source to a valve;
directing the fluid from the valve to a first working unit and a second working unit in parallel, a one of said first and second working units being adapted to receive pressurized fluid on a priority basis from said valve, and passing the fluid from the first and second working units to the reservoir by a circulation conduit;
directing a portion of the fluid from the first and second working units by a bypass conduit to a first heat exchanger;
directing the portion of the fluid from the first heat exchanger to the reservoir.

14. The method of operating a cooling system as claimed in claim 13, including passing the fluid through a filter being positioned in the line of the circulation conduit.

15. The method of operating a cooling system as claimed in claim 14, wherein said filter being positioned between the reservoir and the bypass conduit.

16. The method of operating a cooling system as claimed in claim 13, wherein said first working unit being an implement hydraulic unit.

17. The method of operating a cooling system as claimed in claim 13, wherein said second working unit being a steering unit.

18. The method of operating a cooling system as claimed in claim 13, said valve being a priority valve.

19. The method of operating a cooling system as claimed in claim 13, including passing a smaller amount of fluid flow through an orifice than the fluid flow passed through the circulating conduit, said orifice defined by a narrow conduit part having an inner diameter smaller than an inner diameter of the circulating conduit and being configured in the line of the bypass conduit.

20. The method of operating a cooling system as claimed in claim 19, said orifice being located adjacent to the circulation conduit.

21. The method of operating a cooling system as claimed in claim 13, said first heat exchanger being a cooler of fluid to air type.

22. The method of operating a cooling system as claimed in claim 13, including a control valve being positioned in the line of the bypass conduit.

23. The method of operating a cooling system as claimed in claim 22, wherein said control valve being located adjacent to the first heat exchanger.

24. The method of operating a cooling system as claimed in claim 22, wherein said control valve being a thermostat valve, said thermostat valve being movable to a fluid passing position in response to the temperature reaching a predetermined temperature.

25. A work machine having a first cooling system having a first heat exchanger, a second cooing system having a second heat exchanger and a third cooling system having a third heat exchanger, said first cooling system comprising,
a reservoir configured to hold a supply of fluid;
a source of pressurized fluid;
a valve configured to receive the pressurized fluid from the source of pressurized fluid;
a first working unit and a second working unit being connected to the valve in parallel, one of said first and second working units being adapted to receive pressurized fluid on a priority basis from said valve, said first and second working units being fluidly connected to the reservoir by a circulation conduit and being connected to the first heat exchanger by a bypass conduit, said bypass conduit being configured to pass only a portion of the fluid flow passed from the first and second working units to the first heat exchanger; and
said first heat exchanger being fluidly connected to the reservoir and being adapted to pass said portion of the fluid flow to the reservoir.

26. The work machine as claimed in claim 25, wherein said second heat exchanger being a radiator.

27. The work machine as claimed in claim 25, said third heat exchanger being a cooler.

28. The work machine as claimed in claim 27, wherein said cooler being connected to the lower portion of the second heat exchanger.

29. The work machine as claimed in claim 25, wherein said first heat exchanger being a cooler of fluid to air type.

30. The work machine as claimed in claim 25, further including a filter being positioned in the line of the circulation conduit.

31. The work machine as claimed in claim 30, wherein said filter being positioned between the reservoir and the bypass conduit.

32. The work machine as claimed in claim 25, wherein said first working unit being an implement hydraulic unit.

33. The work machine as claimed in claim 25, wherein said second working unit being a steering unit.

34. The work machine as claimed in claim 25, wherein said valve being a priority valve.

35. The work machine as claimed in claim 25, including an orifice defined by a narrow conduit part having an inner diameter being smaller than the inner diameter of the circulating conduit, said orifice being disposed in the line of the bypass conduit, said orifice passing a smaller amount of fluid flow than the fluid flow passed through the circulating conduit.

36. The work machine as claimed in claim 35, said orifice being located adjacent to the circulation conduit.

37. The work machine as claimed in claim 25, including a control valve being positioned in the line of the bypass conduit.

38. The work machine as claimed in claim 37, wherein said control valve being located adjacent to the first heat exchanger.

39. The work machine as claimed in claim 37, wherein said control valve being a thermostat valve.
